(19) United States
(12) Patent Application Publication
(10) Pub. No.: US 2026/0269237 A1
(43) Pub. Date: Sep. 10, 2026

(54) ELECTRODE ASSEMBLY AND SECONDARY BATTERY INCLUDING SAME

(71) Applicants: Hyundai Motor Company, Seoul (KR); Kia Corporation, Seoul (KR)

(72) Inventors: Seung Ho Ahn, Hwaseong (KR); Yeji Son, Hwaseong (KR); Yoon Ji Lee, Hwaseong (KR); Shinkook Kong, Hwaseong (KR)

(21) Appl. No.: 19/261,586

(22) Filed: Jul. 7, 2025

(30) Foreign Application Priority Data
Mar. 6, 2025 (KR) 10-2025-0028792

(51) Int. Cl. H01M 4/525; H01M 4/02; H01M 4/36; H01M 4/583; H01M 4/62; H01M 10/0567; H01M 10/0568; H01M 10/0569

(52) U.S. Cl. CPC H01M 4/525; H01M 4/366; H01M 4/583; H01M 4/625; H01M 10/0567; H01M 10/0568; H01M 10/0569; H01M 2004/021; H01M 2004/027; H01M 2004/028; H01M 2300/0037

(57) ABSTRACT

The present disclosure relates to an electrode assembly and a secondary battery including the same. The electrode assembly may include a positive electrode including a positive electrode current collector and a positive electrode active material layer, a negative electrode including a negative electrode current collector and a negative electrode active material layer, and a separator interposed between the positive and negative electrodes. The positive electrode active material layer may have a loading amount of 14 mg/cm² or more, the negative electrode active material layer may have a loading amount of 9.2 mg/cm² or more, and an N/P ratio ranges from 1.2 to 1.7. A density of the positive electrode active material layer may range from 2.25 to 2.85 g/cc, or that of the negative electrode active material layer may range from 1.15 to 1.45 g/cc.

### CROSS-REFERENCE TO RELATED APPLICATION

This present application claims under 35 U.S.C. § 119(a) the benefit of Korean Patent Application No. 10-2025-0028792, filed on Mar. 6, 2025, in the Korean Intellectual Property Office, the entire disclosure of which is incorporated herein by reference.

### BACKGROUND

### Technical Field

The present disclosure relates to an electrode assembly and a secondary battery including the same.

### Background

With the recent surge in demand for eco-friendly technologies, intensive research has focused on various energy sources. Among these energy sources, lithium secondary batteries are widely used not only as an energy source for mobile devices such as smartphones and laptops, but also as an energy storage medium for electric vehicles (EVs), hybrid electric vehicles (HEVs), and plug-in hybrid electric vehicles (PHEVs), owing to the high energy density and low self-discharge rate of the lithium secondary batteries.

The performance requirements of EV, HEV, and PHEV battery cells vary according to each vehicle's purpose and design objectives. For example, the HEV battery cells are primarily used to assist vehicle output and therefore need to be designed to provide high power density. To improve the output characteristics of the HEV battery cells, a method of designing electrodes with a reduced thickness has been proposed to shorten the lithium-ion migration path and reduce internal resistance. For instance, a positive electrode and a negative electrode may be designed to have thicknesses of 70 μm or less and 78 μm or less, respectively, including the substrate.

However, reducing the electrode thickness increases the number of electrode layers, thereby complicating the manufacturing process and significantly increasing material and processing costs. To address these issues, an approach of thickening the electrode (electrode thickening) has been reviewed to reduce the manufacturing costs of HEV battery cells. However, this strategy degrades output characteristics.

Meanwhile, in order to implement high output characteristics, an approach has been proposed in which a nickel-based metal oxide (LiNiₓCo_{y}Mn_{z}O₂, NCM) having a high nickel content is used as a positive electrode active material to increase the capacity, thereby reducing the degree of thickening of the electrode. However, to achieve the high output performance required for HEV battery cells, the use of small-sized positive electrode active material particles may lead to side reactions due to the increased nickel content, resulting in degraded high-temperature performance. Accordingly, increasing nickel content alone cannot fully preserve output characteristics.

Thus, there is a need to develop a battery cell that may satisfy the output performance required for HEVs while reducing material and processing costs by thickening the electrode.

### SUMMARY

The following summary presents a simplified summary of certain features. The summary is not an extensive overview and is not intended to identify key or critical elements.

The present disclosure may be realized by providing an electrode assembly capable of improving output characteristics in a secondary battery while reducing manufacturing costs of the secondary battery by thickening an electrode.

In addition, the present disclosure may be realized by providing a secondary battery with improved output characteristics while reducing costs of battery cells by using a thick electrode.

An aspect of the present disclosure provides an electrode assembly, including a positive electrode including a positive electrode current collector and a positive electrode active material layer formed on one or both surfaces of the positive electrode current collector, a negative electrode including a negative electrode current collector and a negative electrode active material layer formed on one or both surfaces of the negative electrode current collector, and a separator interposed between the positive electrode and the negative electrode, wherein a loading amount per unit area of the positive electrode active material layer is about 14 mg/cm² or more, a loading amount per unit area of the negative electrode active material layer is about 9.2 mg/cm² or more, an N/P ratio, which is the ratio of a reversible capacity of the negative electrode measured by charging and discharging from about 1.5 V to 0.01 V to a reversible capacity of the positive electrode measured by charging and discharging from about 4.25 V to 3.0 V, as measured under a constant current condition of ⅓C at 25° C., ranges from about 1.2 to 1.7, and a density of the positive electrode active material layer ranges from about 2.25 g/cc to 2.85 g/cc or a density of the negative electrode active material layer ranges from about 1.15 g/cc to 1.45 g/cc.

The density of the positive electrode active material layer may range from about 2.25 g/cc to 2.85 g/cc, and the density of the negative electrode active material layer may range from about 1.15 g/cc to 1.45 g/cc.

The positive electrode active material layer may include a positive electrode active material having an average particle diameter smaller than about 5 μm.

The positive electrode active material layer may include about 1.5 wt % to 5 wt % of a first conductive material based on the total weight of the positive electrode active material layer.

The negative electrode active material layer may include a negative electrode active material having an average particle diameter smaller than about 12 μm.

The negative electrode active material layer may include about 2 wt % to 6 wt % of a second conductive material based on a total weight of the negative electrode active material layer.

Another aspect of the present disclosure provides a secondary battery including the electrode assembly described above and an electrolyte including a lithium salt and an organic solvent.

The lithium salt may include lithium bis(fluorosulfonyl)imide (LiFSI).

A concentration of the LiFSI in the electrolyte may range from about 0.1 M to 0.8 M.

The organic solvent may include a propionate-based compound.

The propionate-based compound may be present in an amount of about 20 vol % to 90 vol % based on a total volume of the organic solvent.

The electrolyte may further include one or more of additive selected from the group consisting of a vinylene carbonate-based compound, a sulfone-based compound, a sulfite-based compound, a sulfonate-based compound, and a sultone-based compound.

The additive may be present in an amount of about 1 wt % to 10 wt % based on a total weight of the electrolyte.

The electrolyte further may include a sulfate-based compound.

The sulfate-based compound may be present in an amount of about 0.5 wt % to 4 wt % based on a total weight of the electrolyte.

In some embodiments, a secondary battery comprises an electrode assembly including: a positive electrode having a positive electrode current collector, a positive electrode active material layer containing a nickel-cobalt-manganese (NCM)-based lithium oxide whose nickel content is between 0.4 and 0.9 and whose D50 particle diameter is from about 0.5 μm to about 5 μm, the positive-electrode active material having a loading amount ≥14 mg/cm² and a density of about 2.25-2.85 g/cc; and a negative electrode having a negative electrode current collector and a negative electrode active material layer that contains artificial graphite whose average particle diameter is <12 μm, the negative electrode active material layer having a loading amount ≥9 mg/cm² and a density of 1.15-1.45 g/cc; a separator interposed between the positive and negative electrode; and an electrolyte that contains lithium bis(fluorosulfonyl)imide (LiFSI) at a concentration of 0.3-0.8M and uses an organic-solvent system in which a propionate-based compound accounts for 20-90 vol % of the total organic-solvent volume; wherein a constant current condition of ⅓ C at 25° C., an N/P ratio—a ratio of a reversible capacity of the negative electrode measured by charging and discharging from about 1.5 V to 0.01 V to a reversible capacity of the positive electrode measured by charging and discharging from about 4.25 V to 3.0 V—ranges from about 1.2 to 1.7.

The LiFSI concentration may be about 0.6M, and the mixed solvent consists of ethylene carbonate and ethyl methyl carbonate at a volume ratio of about 25:75.

The electrolyte may further comprise about 0.5-5 wt % vinylene carbonate and about 0.5-5 wt % 1,3-propane sultone, each based on the total weight of the electrolyte.

The positive electrode active material layer may additionally contain about 1.5-5 wt % of a first conductive carbon material, based on the total weight of the positive electrode active material layer.

The negative electrode active material layer may additionally contain about 2-6 wt % of a second conductive material selected from carbon black, carbon nanotubes, or a combination thereof.

The electrode assembly according to the present disclosure may have the advantage of reducing manufacturing costs through electrode thickening while improving output characteristics when used in a secondary battery.

In addition, the present disclosure may provide a secondary battery having improved output characteristics.

### BRIEF DESCRIPTION OF THE DRAWINGS

The foregoing and other embodiments, features, and advantages of the disclosure, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. Like reference numbers and designations in the various drawings indicate like elements.

FIG. 1 is a schematic diagram for an electrode assembly according to an example of the present disclosure.

### DETAILED DESCRIPTION

Hereinafter, some embodiments of the present disclosure will be described in more detail. However, the following embodiments are provided merely as references for describing the present disclosure in detail, and the present disclosure is not limited thereto and may be implemented in various forms

Unless otherwise defined, all technical and scientific terms used in the present disclosure have the same meanings as commonly understood by those skilled in the art of this application. The terms “include,” “comprise,” and any variations thereof used in the specification of this application are intended to encompass non-exclusive inclusion.

Embodiments described in the present specification can be modified into various other forms, and the technology according to exemplary embodiments is not limited to the embodiments described below. The exemplary embodiments are provided to make the description of the present disclosure thorough and to fully convey the scope of the present disclosure to those skilled in the art.

Singular forms “a,” “an,” and “the” used in the specification and the appended claims are intended to include plural referents unless the context clearly dictates otherwise.

In addition, numerical ranges used in this specification include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

Furthermore, reference throughout the specification to “including” or “comprising” a constituent element means that, unless specifically stated to the contrary, other constituent elements are not excluded and may be included.

In the present specification, when a layer, film, region, plate, or the like is described as being “on” or “above” another part, it encompasses both cases where it is directly on the other part and cases where the other part is interposed therebetween.

Furthermore, terms including ordinals such as first, second, etc. may be used to describe various elements, but the elements are not limited by these terms. These terms are only used to distinguish one constituent element from another.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “reversible capacity” herein refers to the discharge capacity (mAh) obtained in the first full charge/discharge cycle under the specified voltage window at 25° C.

In the present specification, average particle diameter refers to an average diameter in the case of spherical particles, and to an average major axis length in the case of non-spherical particles. The average particle diameter may be measured using a particle size analyzer (PSA). The average particle diameter refers to D50, which is the particle size corresponding to the cumulative volume of 50%, calculated from the lower end of the particle size range in a particle size distribution measured by, for example, laser diffraction in accordance with ISO 13320.

HEV battery cells are primarily used to assist vehicle output and therefore need to be designed to provide high power density. To improve the output characteristics of the HEV battery cells, a method of designing electrodes with a reduced thickness has been proposed to shorten the lithium-ion migration path and reduce internal resistance. For instance, a positive electrode and a negative electrode may be designed to have thicknesses of 70 μm or less and 78 μm or less, respectively, including the substrate.

However, reducing the electrode thickness may increase the number of electrode layers, thereby complicating the manufacturing process and significantly increasing material and processing costs. To address these issues, an approach of thickening the electrode (electrode thickening) has been reviewed to reduce the manufacturing costs of HEV battery cells. However, this approach results in a deterioration in output characteristics.

Thus, there is a need to develop a battery cell that may satisfy the output performance required for HEVs while reducing material and processing costs by thickening the electrode.

According to one embodiment of the present disclosure, when an N/P ratio, which is the ratio of a reversible capacity of the negative electrode to a reversible capacity of the positive electrode in the electrode assembly, falls within a specific range, and the density of either the positive electrode active material layer or the negative electrode active material layer also falls within a specific range, it is possible to provide an electrode assembly capable of achieving improved output characteristics in a secondary battery even at a high loading amount of the active material layer. In addition, by increasing a loading amount of the active material layer to achieve electrode thickening, it is possible to reduce the manufacturing costs of the electrode assembly and the secondary battery.

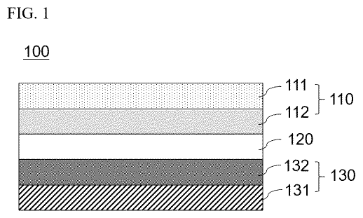

FIG. 1 is a schematic diagram for an electrode assembly according to an example of the present disclosure. Referring to FIG. 1, an electrode assembly (100) according to one embodiment of the present disclosure may include a positive electrode (110) including a positive electrode current collector (111) and a positive electrode active material layer (112) formed on one or both surfaces of the positive electrode current collector (111), a negative electrode (130) including a negative electrode current collector (131) and a negative electrode active material layer (132) formed on one or both surfaces of the negative electrode current collector (131), and a separator (120) interposed between the positive electrode (110) and the negative electrode (130). A loading amount per unit area of the positive electrode active material layer may be about 14 mg/cm² or more, and a loading amount per unit area of the negative electrode active material layer may be about 9.2 mg/cm² or more. The N/P ratio, which is the ratio of the reversible capacity of the negative electrode measured by charging and discharging from about 1.5 V to 0.01 V to the reversible capacity of the positive electrode measured by charging and discharging from about 4.25 V to 3.0 V, as measured under a constant current condition of ⅓C at 25° C., ranges from about 1.2 to 1.7. The density of the positive electrode active material layer may range from about 2.25 g/cc to 2.85 g/cc, or the density of the negative electrode active material layer may range from about 1.15 g/cc to 1.45 g/cc.

According to one embodiment, the loading amount per unit area of the positive electrode active material layer may be 14 mg/cm² or more, 14.5 mg/cm² or more, 15 mg/cm² or more, 15.5 mg/cm² or more, 18.5 mg/cm² or less, 18 mg/cm² or less, 17.5 mg/cm² or less, 17 mg/cm² or less, 16 mg/cm² or less, or a value between 14 and 18.5 mg/cm². For example, the loading amount per unit area of the positive electrode active material layer may range from 14 mg/cm² to 18.5 mg/cm², from 14.5 mg/cm² to 18.5 mg/cm², from 15 mg/cm² to 18 mg/cm², from 15.5 mg/cm² to 17.5 mg/cm², from 15.5 mg/cm² to 17 mg/cm², or from 15.5 mg/cm² to 16 mg/cm².

According to one embodiment, the loading amount per unit area of the negative electrode active material layer may be 9.2 mg/cm² or more, 10 mg/cm² or more, 10.5 mg/cm² or more, 11 mg/cm² or more, 12.5 mg/cm² or less, 12 mg/cm² or less, or a value between 9.2 and 12.5 mg/cm². For example, the loading amount per unit area of the positive electrode active material layer may range from 9.2 mg/cm² to 12.5 mg/cm², from 10 mg/cm² to 12.5 mg/cm², from 10.5 mg/cm² to 12 mg/cm², or from 11 mg/cm² to 12 mg/cm².

The electrode assembly (100) exhibits improved resistance characteristics despite the high loading amount of the electrode active material layer as described above. Accordingly, by applying the electrode assembly (100), it is possible to provide a secondary battery having improved output characteristics at a reduced cost. The loading amount per unit area of the positive (or negative) electrode active material layer is defined as the total weight (mg) of the active material layer formed on one or both surfaces of the positive (or negative) electrode current collector, divided by the total area (cm²) of the active material layer formed on one or both surfaces of the positive (or negative) electrode current collector.

According to one embodiment, the N/P ratio may be 1.2 or more, 1.25 or more, 1.7 or less, 1.5 or less, 1.4 or less, 1.35 or less, or a value between 1.2 and 1.4. For example, the N/P ratio may range from 1.2 to 1.7, from 1.2 to 1.5, from 1.2 to 1.4, or from 1.25 to 1.35.

When the density of the positive or negative electrode active material layer satisfies the range described below and the N/P ratio satisfies the range described above, it is possible to provide the electrode assembly (100) that exhibits improved resistance characteristics despite a high loading amount of the electrode active material layer. Accordingly, the secondary battery including the electrode assembly (100) may have improved output characteristics at a reduced cost. The density of the positive (or negative) electrode active material layer is defined as the total weight (g) of the active material layer formed on one or both surfaces of the positive (or negative) electrode current collector, divided by the total volume (cc) of the active material layer formed on one or both surfaces of the positive (or negative) electrode current collector. The total volume is calculated by multiplying the total area (cm²) of the active material layer by its average thickness (cm), and the unit of the density is expressed in grams per cubic centimeter (g/cc).

The N/P ratio may be measured under a constant current of ⅓C at 25° C. The N/P ratio may refer to the ratio of the reversible capacity of the negative electrode measured by charging and discharging from 1.5 V to 0.01 V to the reversible capacity of the positive electrode measured by charging and discharging from 4.25 V to 3.0 V, as measured under a constant current condition of ⅓C at 25° C. Specifically, the N/P ratio may be measured using a test cell prepared by introducing a liquid electrolyte into an electrode assembly (100) according to one embodiment. The test cell may be a cell including: an electrode assembly (100) according to one embodiment of the present disclosure; and an electrolyte in which LiPF₆ is dissolved at the concentration of 1.2 M in a mixed solvent of ethylene carbonate and ethyl methyl carbonate at a volume ratio of 25:75.

The density of the positive electrode active material layer may range from 2.25 g/cc to 2.85 g/cc, or the density of the negative electrode active material layer may range from 1.15 g/cc to 1.45 g/cc. The density of the positive electrode active material layer may range from 2.25 g/cc to 2.85 g/cc, and the density of the negative electrode active material layer may range from 1.15 g/cc to 1.45 g/cc.

The density of the positive electrode active material layer may be 2.25 g/cc or more, 2.4 g/cc or more, 2.5 g/cc or more, 2.85 g/cc or less, 2.8 g/cc or less, 2.7 g/cc or less, 2.65 g/cc or less, or a value between 2.25 and 2.85 g/cc. For example, the density of the positive electrode active material layer may range from 2.25 g/cc to 2.85 g/cc, from 2.4 g/cc to 2.85 g/cc, from 2.4 g/cc to 2.8 g/cc, from 2.4 g/cc to 2.7 g/cc, or from 2.5 g/cc to 2.65 g/cc.

The density of the negative electrode active material layer may be 1.15 g/cc or more, 1.2 g/cc or more, 1.3 g/cc or more, 1.45 g/cc or less, 1.4 g/cc or less, or a value between 1.15 and 1.45 g/cc. For example, the density of the negative electrode active material layer may range from 1.15 g/cc to 1.45 g/cc, from 1.2 g/cc to 1.45 g/cc, or from 1.3 g/cc to 1.4 g/cc.

The positive electrode active material layer (112) may include a positive electrode active material. The positive electrode active material may have an average particle diameter smaller than about 5 μm. The positive electrode active material may have an average particle diameter of 0.5 μm to less than 5 μm, 2 μm to less than 5 μm, 2 μm to 4 μm, or 2.5 μm to 4 μm. When the average particle diameter of the positive electrode active material falls within the above-described range, the movement distance of lithium ions and the internal resistance may be reduced. Accordingly, a secondary battery having output characteristics that the present disclosure aims to implement may be provided.

The positive electrode active material may be a compound capable of reversible insertion and extraction of lithium ions. Any existing positive electrode active material may be used without limitation. For example, the positive electrode active material may include a lithium-nickel metal oxide. The lithium-nickel metal oxide may further include one or more of element selected from the group consisting of Mg, Sr, Ti, Zr, V, Nb, Ta, Mo, W, B, Al, Fe, Co, Cr, Mn, and Ce.

The positive electrode active material may include a nickel-cobalt-manganese (NCM)-based lithium oxide. The content of nickel (Ni) in the NCM-based lithium oxide may be from about 0.4 to 0.9. In terms of improved high-temperature storage characteristics along with output characteristics, the content of nickel (Ni) in the NCM-based lithium oxide may be from 0.4 to 0.75 or from 0.6 to 0.7. Here, the content of nickel (Ni) refers to the mole fraction of nickel based on the total number of moles of nickel, cobalt, and manganese.

The positive electrode active material may include a lithium cobalt oxide-based active material, a lithium manganese oxide-based active material, a lithium nickel oxide-based active material, or a lithium iron phosphate (LFP)-based active material (e.g., LiFePO₄).

The positive electrode active material layer (112) may further include a first conductive material. The first conductive material may be added to enhance the conductivity of the positive electrode active material layer and/or the mobility of lithium ions or electrons.

The positive electrode active material layer (112) may include about 1 wt % to 8 wt % of a first conductive material based on the total weight of the positive electrode active material layer (112).

In a preferred embodiment, the positive electrode active material layer (112) may include about 1.5 wt % to 5 wt % of a first conductive material based on the total weight of the positive electrode active material layer (112). When the first conductive material is included in the above content, the conductivity of the positive electrode active material layer and/or the mobility of lithium ions or electrons may be substantially enhanced. Accordingly, a secondary battery with significantly improved output characteristics may be provided.

The first conductive material may be used without limitation when it is a conductive material known in the art. For example, the first conductive material may include a nonlinear conductive material, a linear conductive material, or a combination of the two. For example, the nonlinear conductive material may include one or more of selected from the group consisting of natural graphite, artificial graphite, carbon black, acetylene black, Ketjen black, channel black, furnace black, lamp black, thermal black, conductive fibers, fluorocarbon, aluminum powder, nickel powder, zinc oxide, potassium titanate, titanium oxide, and polyphenylene derivatives. The linear conductive material may include carbon nanotubes (CNTs), and the carbon nanotubes may be single-walled, double-walled, or multi-walled carbon nanotubes.

The positive electrode active material layer (112) may further include a first binder. The first binder may be present in an amount of about 0.1 wt % to 5 wt %, 0.5 wt % to 2 wt %, or 0.7 wt % to 1.8 wt % based on the total weight of the positive electrode active material layer (112).

The first binder may be used without limitation when it is a binder known in the art. For example, the first binder may include one or more of selected from the group consisting of polyvinylidene fluoride (PVDF), poly(vinylidene fluoride-co-hexafluoropropylene), polyacrylonitrile, polymethyl methacrylate, acrylonitrile-butadiene rubber (NBR), polybutadiene rubber (BR), and styrene-butadiene rubber (SBR).

The positive electrode active material layer (112) may further include a dispersant. The dispersant may be present in an amount of about 0.1 wt % to 5 wt %, 0.1 wt % to 2 wt %, or 0.1 wt % to 1 wt % based on the total weight of the positive electrode active material layer (112).

The dispersant may be used without limitation when it is a dispersant known in the art. For example, the dispersant may include acrylonitrile-butadiene rubber (NBR), polyacrylic acid (PAA), polyvinyl alcohol (PVA), carboxymethyl cellulose (CMC), or a combination thereof.

For example, the positive electrode active material layer (112) may include about 90 wt % to 98.5 wt % of the positive electrode active material, about 1 wt % to 8 wt % of the first conductive material, about 0.1 wt % to 5 wt % of the first binder, and about 0.1 wt % to 5 wt % of the dispersant. The positive electrode active material layer (112) may include about 93.2 wt % to 97.8 wt % of the positive electrode active material, about 1.5 wt % to 5 wt % of the first conductive material, about 0.5 wt % to 2 wt % of the first binder, and about 0.1 wt % to 2 wt % of the dispersant.

The negative electrode active material layer (132) may include a negative electrode active material. The negative electrode active material may have an average particle diameter smaller than about 12 μm. The negative electrode active material may have the average particle diameter of 1 μm to 12 μm, 2 μm to 10 μm, 3 μm to 9 μm, or 5 μm to 9 μm. When the average particle diameter of the negative electrode active material falls within the above-described range, the movement distance of lithium ions and the internal resistance may be reduced. Accordingly, a secondary battery having output characteristics that the present disclosure aims to implement may be provided.

The negative electrode active material may be a compound capable of absorbing and desorbing lithium ions. Any existing negative electrode active material may be used without limitation. For example, the negative electrode active material may include: a carbon-based material such as crystalline carbon, amorphous carbon, a carbon composite, or carbon fiber; lithium metal; a lithium alloy; a silicon (Si)-containing material; a tin (Sn)-containing material, or the like.

Examples of the crystalline carbon may include graphite-based carbon such as natural graphite, artificial graphite, graphitized coke, graphitized mesocarbon microbeads (MCMB), and graphitized mesophase pitch-based carbon fiber (MPCF).

Examples of the amorphous carbon may include hard carbon, soft carbon, coke, mesocarbon microbeads (MCMB), mesophase pitch-based carbon fiber (MPCF), and the like.

The lithium metal may be pure lithium metal or lithium metal having a protective layer formed thereon to suppress dendrite growth or the like.

Examples of elements included in the lithium alloy may include aluminum, zinc, bismuth, cadmium, antimony, silicon, lead, tin, gallium, or indium.

The silicon-containing material may provide improved capacity characteristics. The silicon-containing material may include Si, SiOx (0<x<2), metal-doped SiOx (0<x<2), a silicon-carbon composite, or the like. The metal may include lithium and/or magnesium, and the metal-doped SiOx (0<x<2) may include a metal silicate.

The negative electrode active material layer (132) may further include a second conductive material. The second conductive material may be added to enhance the conductivity of the negative electrode active material layer and/or the mobility of lithium ions or electrons.

The negative electrode active material layer (132) may include about 1 wt % to 8 wt % of the second conductive material based on the total weight of the negative electrode active material layer (132).

In a preferred embodiment, the negative electrode active material layer (132) may include about 2 wt % to 5 wt %, or 2 wt % to 5 wt % of the second conductive material based on the total weight of the negative electrode active material layer (132). When the second conductive material is included in the above content, the conductivity of the negative electrode active material layer and/or the mobility of lithium ions or electrons may be enhanced to a maximum. Accordingly, a secondary battery with significantly improved output characteristics may be provided.

The second conductive material may be used without limitation as long as it is a conductive material known in the art, and since the description regarding the first conductive material is applicable to the second conductive material, a detailed explanation is omitted.

The negative electrode active material layer (132) may further include a second binder. The second binder may be present in an amount of about 0.1 wt % to 5 wt %, or 0.5 wt % to 2 wt % based on the total weight of the negative electrode active material layer (132).

The second binder may be used without limitation as long as it is a binder known in the art, and since the description regarding the first binder is applicable to the second binder, a detailed explanation is omitted.

The negative electrode active material layer (132) may further include a thickening agent. The thickening agent may be present in an amount of about 0.1 wt % to 5 wt %, or 0.5 wt % to 2 wt % based on the total weight of the negative electrode active material layer (132).

The thickening agent may be used without limitation when it is a thickening agent known in the art. For example, the thickening agent may include polyacrylic acid (PAA), polyvinyl alcohol (PVA), carboxymethyl cellulose (CMC), or a combination thereof.

For example, the negative electrode active material layer (132) may include about 85 wt % to 98 wt % of the negative electrode active material, about 1 wt % to 8 wt % of the second conductive material, about 0.1 wt % to 5 wt % of the second binder, and about 0.1 wt % to 5 wt % of the thickening agent. The negative electrode active material layer (132) may include about 90 wt % to 96.6 wt % of the negative electrode active material, about 2 wt % to 6 wt % of the second conductive material, about 0.5 wt % to 2 wt % of the second binder, and about 0.5 wt % to 2 wt % of the thickening agent.

The positive electrode current collector (111) may include stainless steel, nickel, aluminum, titanium, or an alloy thereof. The positive electrode current collector (111) may include aluminum or stainless-steel surface-treated with carbon, nickel, titanium, or silver, but is not limited thereto.

The negative electrode current collector (131) may include copper foil, nickel foil, stainless steel foil, titanium foil, nickel foam, copper foam, or a polymer substrate coated with a conductive metal, but is not limited thereto.

The separator (120) may be an insulating microporous film that conducts active ions such as lithium ions and prevents electrical short-circuiting between the positive electrode (110) and the negative electrode (130). An example of the separator (120) may include one or more of porous film selected from the group consisting of polyethylene, polypropylene, polybutylene, polypentene, polymethylpentene, polyethylene terephthalate, polybutylene terephthalate, polyacetal, polyamide, polycarbonate, polyimide, polyethersulfone, polyphenylene oxide, polyphenylene sulfide, polyethylene naphthalate, polyvinylidene fluoride, polyvinylidene fluoride-hexafluoropropylene, polymethyl methacrylate, polystyrene, polyvinyl acetate, polyacrylonitrile, polyethylene oxide, and copolymers thereof, but is not limited thereto.

The electrode assembly (100) may have a multilayer structure in which a positive electrode (110), a separator (120), and a negative electrode (130) are formed as a single unit laminate, and two or more of the unit laminates are repeatedly stacked. The electrode assembly (100) may be of a winding type, stacking type, z-folding type, or stack-folding type.

A secondary battery according to one embodiment of the present disclosure may include the electrode assembly (100) as described above, and an electrolyte including a lithium salt and an organic solvent. The secondary battery may have improved output characteristics at reduced cost by including the electrode assembly (100) according to one embodiment.

The lithium salt is dissolved in the organic solvent and serves as a source of lithium ions in the battery, enabling the basic operation of the secondary battery and promoting the movement of lithium ions between the positive electrode and the negative electrode. The lithium salt may include one or more selected from the group consisting of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂.

The concentration of the total lithium salt present in the electrolyte may range from about 0.1 M to 2.0 M. When the concentration of the total lithium salt is within the above range, the electrolyte may have appropriate conductivity and viscosity, thereby exhibiting improved electrolyte performance and allowing lithium ions to move effectively.

A secondary battery according to one embodiment of the present disclosure may have improved output characteristics by including lithium bis(fluorosulfonyl)imide (LiN(SO₂F)₂, LiFSI) as the lithium salt, and in particular, the output characteristics at low temperatures may be improved. The lithium salt may include LiFSI alone or in combination with one or more lithium salts selected from the group described above. The concentration of LiFSI in the electrolyte may be in the range of 0.1 M to 0.8 M in terms of low-temperature output characteristics.

The organic solvent may include a carbonate-based compound. The carbonate-based compound may include a cyclic carbonate compound, a linear carbonate compound, or a combination thereof.

When the organic solvent is a mixed solvent of a cyclic carbonate compound and a linear carbonate compound, the volume ratio of the cyclic carbonate compound to the linear carbonate compound may range from about 1:1 to 1:9 or from about 1:1.5 to 1:4. However, the volume ratio is not particularly limited thereto.

The cyclic carbonate compound may include one or more selected from the group consisting of ethylene carbonate, propylene carbonate, butylene carbonate, and fluoroethylene carbonate.

The linear carbonate compound may include one or more selected from the group consisting of dimethyl carbonate, diethyl carbonate, dipropyl carbonate, ethyl methyl carbonate, methyl propyl carbonate, and ethyl propyl carbonate.

A secondary battery according to one embodiment of the present disclosure may include a propionate compound as the organic solvent. Accordingly, the secondary battery may have improved output characteristics, and particularly, the output characteristics at low temperatures may be enhanced. The organic solvent may include the propionate compound alone or in combination with one or more organic solvents selected from the above-described organic solvents. The organic solvent may include the propionate compound together with the above-described cyclic carbonate compound, linear carbonate compound, or a combination thereof.

The propionate-based compound may refer to a compound containing a propionate group derived from propionic acid (CH₃CH₂COOH), including salts or esters thereof.

The propionate-based compound may include one or more selected from the group consisting of methyl propionate, ethyl propionate, and propyl propionate.

In a preferred embodiment, the propionate-based compound may be present in an amount of about 20 vol % to 90 vol %, or 30 vol % to 90 vol % based on a total volume of the organic solvent. More preferably, the propionate-based compound may be present in an amount of about 60 vol % to 90 vol % based on a total volume of the organic solvent. When the propionate-based compound may be included in the above-described vol % range, the output characteristics at low temperatures may be further improved.

The electrolyte may further include one or more of additive selected from the group consisting of a vinylene carbonate-based compound, a sulfone-based compound, a sulfite-based compound, a sulfonate-based compound, and a sultone-based compound.

Non-limiting examples of the vinylene carbonate-based compound may include vinylene carbonate (VC) and vinyl ethylene carbonate (VEC).

Non-limiting examples of the sulfone-based compound may include dimethyl sulfone, diphenyl sulfone, and divinyl sulfone.

Non-limiting examples of the sulfite-based compound may include ethylene sulfite and propylene sulfite.

Non-limiting examples of the sulfonate-based compound may include diallyl sulfonate, methyl methanesulfonate, and ethyl methanesulfonate.

Non-limiting examples of the sultone-based compound may include ethane sultone, propane sultone (PS), butane sultone, ethene sultone, propene sultone, and butene sultone.

The additive may be present in an amount of about 1 wt % to 10 wt %, 1 wt % to 9 wt %, or 1 wt % to 5 wt % based on the total weight of the electrolyte.

The electrolyte further may include a sulfate-based compound. Accordingly, it is possible to provide a secondary battery with improved high-temperature storage characteristics.

The sulfate-based compound may be includ present ed in an amount of about 0.5 wt % to 5 wt %, 0.5 wt % to 4 wt %, or 0.5 wt % to 2 wt % based on the total weight of the electrolyte.

In a preferred embodiment, the electrolyte may include the lithium salt, the organic solvent including the propionate-based compound, and the sulfate-based compound. Accordingly, it is possible to provide a secondary battery with improved high-temperature storage characteristics and output characteristics at low temperatures. The sulfate-based compound may be ethylene sulfate (ESA).

The electrolyte may include vinylene carbonate (VC), propane sultone (PS), and ethylene sulfate (ESA), together with the lithium salt and the organic solvent. The vinylene carbonate (VC) may be present in an amount of about 0.5 wt % to 5 wt %, 0.5 wt % to 4 wt %, or 0.5 wt % to 2 wt % based on the total weight of the electrolyte. The propane sultone (PS) may be present in an amount of about 0.5 wt % to 5 wt %, or 1 wt % to 3 wt % based on the total weight of the electrolyte. The ethylene sulfate (ESA) may be present in an amount of about 0.5 wt % to 5 wt %, 0.5 wt % to 4 wt %, or 0.5 wt % to 2 wt % based on the total weight of the electrolyte.

Hereinafter, Examples are specifically illustrated and described. However, the following Examples are provided for illustrative purposes only, and the technology described in this specification is not limited thereto.

### Example 1

### Preparation of Positive Electrode

A positive electrode active material slurry was prepared by dispersing 96.3 wt % of LiNi_{0.6}Co_{0.2}Mn_{0.2}O₂ (D50: 3 μm) as a positive electrode active material, 1.5 wt % of polyvinylidene fluoride (PVDF) as a first binder, 1.0 wt % of carbon black and 1.0 wt % of carbon nanotube (CNT) as first conductive agent, and 0.2 wt % of acrylonitrile-butadiene rubber (NBR) as a dispersant in N-methylpyrrolidone.

The positive electrode active material slurry was coated on an Al foil current collector having a thickness of 14 μm, then dried and rolled to prepare the positive electrode with a positive electrode active material layer formed on the current collector. The positive electrode was prepared to have a loading amount per unit area of 15.9 mg/cm² and a density of 2.6 g/cc.

### Preparation of Negative Electrode

A negative electrode active material slurry was prepared by mixing 94.8 wt % of artificial graphite (D50: 7.5 μm) as a negative electrode active material, 1.2 wt % of styrene-butadiene rubber (SBR) as a second binder, 3.0 wt % of carbon black as a second conductive agent, and 1.0 wt % of carboxymethyl cellulose (CMC) as a thickener, and dispersing the mixture in distilled water. The negative electrode active material slurry was coated on a Cu foil current collector having a thickness of 10 μm, then dried at 100° C. and rolled to prepare the negative electrode with a negative electrode active material layer formed on the current collector. The negative electrode was prepared to have a loading amount per unit area of 11.1 mg/cm² and a density of 1.5 g/cc.

### Preparation of Electrode Assembly

An electrode assembly was prepared by interposing a polyethylene separator having a thickness of 15 μm between the prepared positive electrode and negative electrode.

Using a test cell to which the electrode assembly was applied, the reversible capacity of the positive electrode was measured by charging and discharging from 4.25 V to 3.0 V, and the reversible capacity of the negative electrode was measured by charging and discharging from 1.5 V to 0.01 V, under a constant current condition of ⅓C at 25° C. Based on this, the ratio (N/P ratio) of the reversible capacity of the negative electrode to that of the positive electrode was determined to be 1.27. Specifically, the test cell was prepared by injecting an electrolyte into the prepared electrode assembly, wherein the electrolyte consisted of 1.2 M lithium salt (LiPF₆) dissolved in a mixed organic solvent of ethylene carbonate (EC) and ethyl methyl carbonate (EMC) at a volume ratio of 25:75.

### Preparation of Electrolyte

An electrolyte was prepared by dissolving 1.2 M lithium salt (LiPF₆) in a mixed organic solvent of ethylene carbonate (EC) and ethyl methyl carbonate (EMC) at a volume ratio of 25:75 and adding 1 wt % of vinylene carbonate (VC) and 2 wt % of 1,3-propane sultone (PS) as additives, based on the total weight of the electrolyte.

### Preparation of Secondary Battery

A secondary battery was prepared by inserting the prepared electrode assembly into a pouch-type battery case and injecting the prepared electrolyte.

### Examples 2 to 4

Except that the compositions for preparing a positive electrode active material slurry and a negative electrode active material slurry were changed as listed in Table 1, and that only carbon black was used as the first conductive agent, secondary batteries were prepared in the same manner as in Example 1.

TABLE 1

| (wt %) | Example 1 | Example 2 | Example 3 | Example 4 |
|---|---|---|---|---|
| Positive electrode active material | 96.3 | 97.5 | 93.2 | 91.2 |
| First conductive agent | 2.0 | 1.0 | 5.0 | 7.0 |
| First binder | 1.5 | 1.5 | 1.5 | 1.5 |
| Dispersant | 0.2 | — | 0.3 | 0.3 |
| Negative electrode active material | 94.8 | 96.8 | 94.8 | 90.8 |
| Second conductive agent | 3.0 | 1.0 | 3.0 | 7.0 |
| Second binder | 1.2 | 1.2 | 1.2 | 1.2 |
| Thickening agent | 1.0 | 1.0 | 1.0 | 1.0 |

### Examples 5 to 8

Except for the changes in a loading amount and density of a positive electrode active material layer and a negative electrode active material layer as listed in Table 2, secondary batteries were prepared in the same manner as in Example 1. Additionally, the N/P ratio was measured in the same manner as in Example 1 and recorded in Table 2.

TABLE 2

| | Example 1 | Example 5 | Example 6 | Example 7 | Example 8 |
|---|---|---|---|---|---|
| Positive electrode loading | 15.9 | 15.9 | 15.9 | 15.9 | 15.9 |
| amount (mg/cm²) | | | | | |
| Positive electrode density | 2.6 | 2.9 | 2.6 | 2.6 | 2.4 |
| (g/cc) | | | | | |
| Negative electrode loading | 11.1 | 11.1 | 11.1 | 12.5 | 12.5 |
| amount (mg/cm²) | | | | | |
| Negative electrode density | 1.5 | 1.4 | 1.4 | 1.4 | 1.15 |
| (g/cc) | | | | | |
| N/P ratio | 1.27 | 1.27 | 1.27 | 1.4 | 1.27 |

### Examples 9 to 12

Secondary batteries were prepared in the same manner as in Example 6, except that an electrolyte composition and content were changed as listed in Table 3 below.

TABLE 3

| | Example 6 | Example 9 | Example 10 | Example 11 | Example 12 |
|---|---|---|---|---|---|
| Lithium salt | 1.2M LiPF₆ | 0.6M LiPF₆ | 1.2M LiPF₆ | 1.2M LiPF₆ | 1.2M LiPF₆ |
| | | 0.6M LIFSI | | | |
| EC:EMC:EP(vol %) | 25:75:0 | 25:75:0 | 25:45:30 | 25:0:75 | 25:0:75 |
| VC(wt %) | 1 | 1 | 1 | 1 | 1 |
| PS(wt %) | 2 | 2 | 2 | 2 | 2 |
| ESA(wt %) | — | — | — | — | 1 |

* EP: ethyl propionate
* ESA: ethylene sulfate

### Comparative Examples 1 to Comparative Examples 4

Except for the changes in a loading amount and density of a positive electrode active material layer and a negative electrode active material layer as listed in Table 4, secondary batteries were prepared in the same manner as in Example 1. In Comparative Example 1, three additional positive electrodes and three additional negative electrodes were stacked compared to Example 1. Additionally, the N/P ratio was measured in the same manner as in Example 1 and recorded in Table 4.

TABLE 4

| | Example | Comparative | Comparative | Comparative | Comparative |
|---|---|---|---|---|---|
| | 1 | Example 1 | Example 2 | Example 3 | Example 4 |
| Positive electrode | 15.9 | 13.7 | 15.9 | 15.9 | 15.9 |
| loading amount (mg/cm²) | | | | | |
| Positive electrode density | 2.6 | 2.9 | 2.9 | 2.9 | 2.6 |
| (g/cc) | | | | | |
| Negative electrode | 11.1 | 9.1 | 10.5 | 11.1 | 10.1 |
| loading amount (mg/cm²) | | | | | |
| Negative electrode | 1.5 | 1.5 | 1.5 | 1.5 | 1.4 |
| density (g/cc) | | | | | |
| N/P ratio | 1.27 | 1.15 | 1.15 | 1.27 | 1.15 |

### <Experimental Example> Secondary Battery Performance Evaluation

To evaluate the performance of the secondary batteries, output characteristics and high-temperature stability were measured.

The output characteristics were measured at room temperature (25° C.) and low temperature (−15° C.), respectively. Specifically, the secondary batteries prepared in the Examples and Comparative Examples were fully charged in CC-CV mode (1.0 C, 4.2 V, 0.05 C CUT-OFF), and then discharged to a state of charge (SOC) of 55% at 1 C. Subsequently, constant-power discharge was initiated, and the output value was measured when the voltage reached 2.5 V after 3 seconds.

For high-temperature stability, the secondary batteries prepared in the Examples and Comparative Examples were stored at SOC 95% in a 60° C. chamber for 4 weeks, and then a thickness increase rate was measured. Specifically, the initial thickness of the secondary batteries before storage in the 60° C. chamber were measured using a flat plate thickness measurement device (Mitutoyo, 543-490B). After storage at 60° C. chamber for 4 weeks, the thickness of the secondary batteries were measured again using the same device. The thickness increase rate was calculated as a percentage by dividing the thickness after storage by the initial thickness.

Thickness increase rate (%)=(battery thickness after high-temperature storage/initial battery thickness)×100

TABLE 5

| | Room-temperature | Low-temperature | Thickness |
|---|---|---|---|
| | discharge | discharge | increase |
| | output (W/kg) | output (W/kg) | rate (%) |
| Example 1 | 10,421 | 3,462 | 103 |
| Example 2 | 9,836 | 3,278 | 102 |
| Example 3 | 10,141 | 3,450 | 103 |
| Example 4 | 9,948 | 3,445 | 103 |
| Example 5 | 10,375 | 3,477 | 103 |
| Example 6 | 10,983 | 3,482 | 103 |
| Example 7 | 10,370 | 3,455 | 103 |
| Example 8 | 10,480 | 3,426 | 103 |
| Example 9 | 11,028 | 4,216 | 107 |
| Example 10 | 11,235 | 3,979 | 105 |
| Example 11 | 11,492 | 4,385 | 107 |
| Example 12 | 11,514 | 4,392 | 104 |
| Comparative | 11,617 | 4,213 | 104 |
| Example 1 | | | |
| Comparative | 9,367 | 3,114 | 104 |
| Example 2 | | | |
| Comparative | 9,938 | 3,288 | 104 |
| Example 3 | | | |
| Comparative | 9,417 | 3,079 | 103 |
| Example 4 | | | |

Referring to Tables 1 to 5, Comparative Examples 2 to 4, which do not have an N/P ratio within the range of 1.2 to 1.7 or fail to meet the specified densities of the positive and negative electrode active material layers, exhibited significantly degraded output characteristics under high active material loading conditions.

On the other hand, it may be seen that the secondary batteries of Examples 1 to 12, which have an N/P ratio within the range of 1.2 to 1.7 and satisfy specific values for the density of the positive and/or negative electrode active material layers, exhibit output characteristics similar to or superior to those of Comparative Example 1, even when the loading amount per unit area of the positive electrode active material layer is 14 mg/cm² or more and that of the negative electrode active material layer is 9.2 mg/cm² or more.

The present disclosure described above is not limited by the aspects described herein and the accompanying drawings. It should be apparent to those skilled in the art that various substitutions, changes, and modifications, which are not exemplified herein but are still within the spirit and scope of the present disclosure, may be made. Therefore, the scope of the present disclosure is defined not by the detailed description but by the claims and their equivalents, and all variations within the scope of the claims and their equivalents are to be construed as included in the present disclosure.

The present disclosure described as above is not limited by the aspects described herein and the accompanying drawings. It should be apparent to those skilled in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. An electrode assembly comprising:
a positive electrode comprising a positive electrode current collector and a positive electrode active material layer formed on one or both surfaces of the positive electrode current collector;
a negative electrode comprising a negative electrode current collector and a negative electrode active material layer formed on one or both surfaces of the negative electrode current collector; and
a separator interposed between the positive electrode and the negative electrode,
wherein a loading amount per unit area of the positive electrode active material layer is about 14 mg/cm² or more,
wherein a loading amount per unit area of the negative electrode active material layer is about 9.2 mg/cm² or more,
wherein under a constant current condition of ⅓ C at 25° C., an N/P ratio—a ratio of a reversible capacity of the negative electrode measured by charging and discharging from about 1.5 V to 0.01 V to a reversible capacity of the positive electrode measured by charging and discharging from about 4.25 V to 3.0 V—ranges from about 1.2 to 1.7, and
wherein a density of the positive electrode active material layer ranges from about 2.25 g/cc to 2.85 g/cc or a density of the negative electrode active material layer ranges from about 1.15 g/cc to 1.45 g/cc.

2. The electrode assembly according to claim 1, wherein the density of the positive electrode active material layer ranges from about 2.25 g/cc to 2.85 g/cc, and the density of the negative electrode active material layer ranges from about 1.15 g/cc to 1.45 g/cc.

3. The electrode assembly according to claim 1, wherein the positive electrode active material layer comprises a positive electrode active material having an average particle diameter smaller than about 5 μm.

4. The electrode assembly according to claim 1, wherein the positive electrode active material layer comprises about 1.5 wt % to 5 wt % of a first conductive material, based on a total weight of the positive electrode active material layer.

5. The electrode assembly according to claim 1, wherein the negative electrode active material layer comprises a negative electrode active material having an average particle diameter smaller than about 12 μm.

6. The electrode assembly according to claim 1, wherein the negative electrode active material layer comprises about 2 wt % to 6 wt % of a second conductive material, based on a total weight of the negative electrode active material layer.

7. A secondary battery comprising:
the electrode assembly according to claim 1; and
an electrolyte comprising a lithium salt and an organic solvent.

8. The secondary battery according to claim 7, wherein the lithium salt comprises lithium bis(fluorosulfonyl)imide (LiFSI).

9. The secondary battery according to claim 8, wherein a concentration of the LiFSI in the electrolyte ranges from about 0.1 M to 0.8 M.

10. The secondary battery according to claim 7, wherein the organic solvent comprises a propionate-based compound.

11. The secondary battery according to claim 10, wherein the propionate-based compound is present in an amount of about 20 vol % to 90 vol % based on a total volume of the organic solvent.

12. The secondary battery according to claim 7, wherein the electrolyte further comprises one or more of additive selected from the group consisting of a vinylene carbonate-based compound, a sulfone-based compound, a sulfite-based compound, a sulfonate-based compound, and a sultone-based compound.

13. The secondary battery according to claim 12, wherein the additive is present in an amount of about 1 wt % to 10 wt % based on a total weight of the electrolyte.

14. The secondary battery according to claim 7, wherein the electrolyte further comprises a sulfate-based compound.

15. The secondary battery according to claim 14, wherein the sulfate-based compound is present in an amount of about 0.5 wt % to 4 wt %, based on a total weight of the electrolyte.

16. A second battery comprising
an electrode assembly that includes
a positive electrode having a positive electrode current collector, a positive electrode active material layer containing a nickel-cobalt-manganese (NCM)-based lithium oxide whose nickel content is between 0.4 and 0.9 and whose D50 particle diameter is from about 0.5 μm to about 5 μm, the positive-electrode active material having a loading amount ≥14 mg/cm² and a density of about 2.25-2.85 g/cc; and
a negative electrode having a negative electrode current collector and a negative electrode active material layer that contains artificial graphite whose average particle diameter is <12 μm, the negative electrode active material layer having a loading amount ≥9 mg/cm² and a density of 1.15-1.45 g/cc;
a separator interposed between the positive and negative electrode; and
an electrolyte that contains lithium bis(fluorosulfonyl)imide (LiFSI) at a concentration of 0.3-0.8M and uses an organic-solvent system in which a propionate-based compound accounts for 20-90 vol % of the total organic-solvent volume;
wherein a constant current condition of ⅓ C at 25° C., an N/P ratio—a ratio of a reversible capacity of the negative electrode measured by charging and discharging from about 1.5 V to 0.01 V to a reversible capacity of the positive electrode measured by charging and discharging from about 4.25 V to 3.0 V—ranges from about 1.2 to 1.7.

17. The second battery of claim 16, wherein the LiFSI concentration is about 0.6M, and the mixed solvent consists of ethylene carbonate and ethyl methyl carbonate at a volume ratio of about 25:75.

18. The second battery of claim 16, wherein the electrolyte further comprises about 0.5-5 wt % vinylene carbonate and about 0.5-5 wt % 1,3-propane sultone, each based on the total weight of the electrolyte.

19. The second battery of claim 16, wherein the positive electrode active material layer additionally contains about 1.5-5 wt % of a first conductive carbon material, based on the total weight of the positive electrode active material layer.

20. The second battery of claim 16, wherein the negative electrode active material layer additionally contains about 2-6 wt % of a second conductive material selected from carbon black, carbon nanotubes, or a combination thereof.
